(19) United States
(12) Patent Application Publication
(10) Pub. No.: US 2025/0363967 A1
(43) Pub. Date: Nov. 27, 2025

(54) Finger Coverings for Playing Stringed Instruments

(71) Applicant: Benjamin Garthwaite Goslin, Tampa, FL (US)

(72) Inventor: Benjamin Garthwaite Goslin, Tampa, FL (US)

(21) Appl. No.: 19/219,562

(22) Filed: May 27, 2025

Related U.S. Application Data
(60) Provisional application No. 63/651,865, filed on May 24, 2024.

(51) Int. Cl. G10D 3/00; A41D 13/08

(52) U.S. Cl. CPC G10D 3/00; A41D 13/087

(57) ABSTRACT

The present invention relates to a fingertip covering designed to fit the natural contours of the user's fingers and fingertips. Comprising a rounded central fingertip section and a split band extending therefrom, the covering is adjustable for comfort and snugness. Made from various solid materials, the covering can vary in thickness to produce different sounds when used as a slide on stringed instruments. The fingertip section may include an engraving to enhance grip, and the covering may feature a V-shaped relief cut for the interior knuckle fold. Additionally, a nano-coating may be applied to facilitate sliding and maintain cleanliness. The invention provides utility in musical performance, finger protection, and other fingertip-related activities.

The current application claims a priority to the U.S. Provisional Patent application Ser. No. 63/651,865 filed on May 24, 2024.

### FIELD OF THE INVENTION

The present invention relates generally to accessories for musicians. More specifically, the present invention relates to finger coverings for playing stringed instruments.

### BACKGROUND OF THE INVENTION

Slide guitar is a technique used by musicians to modify the sound of traditional guitars or other stringed instruments. Typically, a slide is a tube or cylinder placed over one of the musician's fingers. The slide allows the musician to move the slide along the strings and create different glissando, vibrato, or other sound effects.

The present invention seeks to provide a different type of guitar slide that can be placed on individual fingertips, allowing the slides to be smaller in size and more customizable to provide additional control over the sounds that can be produced. The fingertip slides further allow the user to easily switch between playing methods by maintaining the use of the fingertips. Existing fingertip slides, like the slides in U.S. Pat. No. 9,255,815 by Maldonado (“the '815 patent”) have thick walls that create interferences when a user tries to move their fingers naturally. The present invention was created with the intent of using 4 slides at the same time, by providing individual slides which are minimalistic in fingerprint area coverage for ergonomics and conformity to a close fit. This allows a player's fingertips to avoid interfering with the slides on the player's other fingers.

### SUMMARY OF THE INVENTION

The present invention is a fingertip covering that can be used when playing stringed instruments. The present invention is placed on the fingertip and has bands that wrap around the finger to hold it in place, allowing the user to create slide sound effects while playing a guitar or other stringed instrument.

### BRIEF DESCRIPTION OF THE DRAWINGS

FIG. 1 is a perspective view of the present invention.

FIG. 2 shows the present invention worn on an index and middle finger.

FIG. 3 shows a side view of the present invention worn on a finger.

FIG. 4 shows the present invention in use.

FIG. 5 shows the present invention in use.

FIG. 6 shows the present invention in use.

FIG. 7 shows the present invention worn on four fingers.

### DETAILED DESCRIPTION OF THE INVENTION

All illustrations of the drawings are for the purpose of describing selected versions of the present invention and are not intended to limit the scope of the present invention.

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is an illustrative, exemplary embodiment for the present disclosure made for the purposes of providing a full and enabling disclosure. The detailed disclosure herein of one or more embodiments is not intended, nor is it to be construed, to limit the scope of patent protection afforded in any claim of a patent issuing here from, which scope is to be defined by the claims and the equivalents thereof. It is not intended that the scope of patent protection be defined by reading into any claim or limitation found herein that does not explicitly appear in the claim itself.

Thus, for example, any sequence(s) and/or temporal order of steps of various processes or methods that are described herein are illustrative and not restrictive. Accordingly, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the appended claims.

The present disclosure includes many aspects and features. Moreover, while many aspects and features relate to, and are described in the context of finger coverings for playing stringed instruments, embodiments of the present disclosure are not limited to use only in this context.

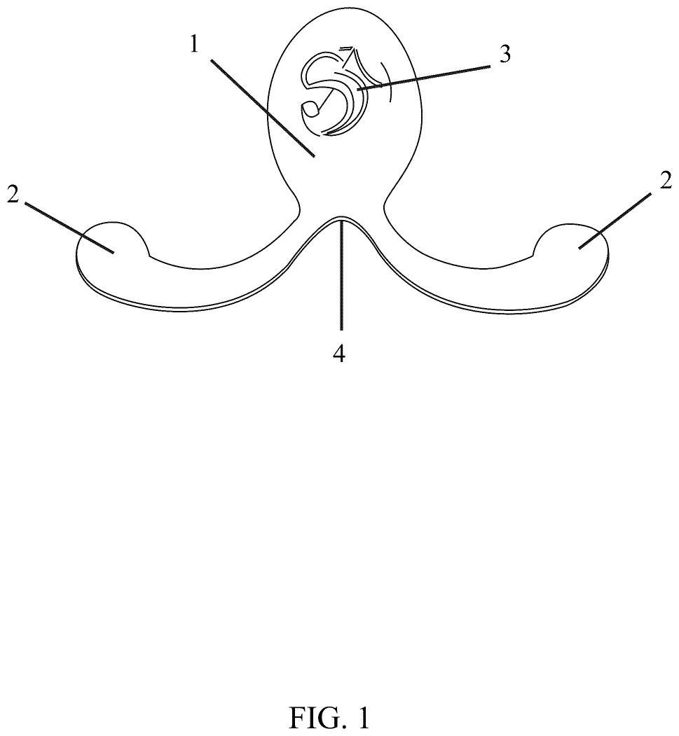

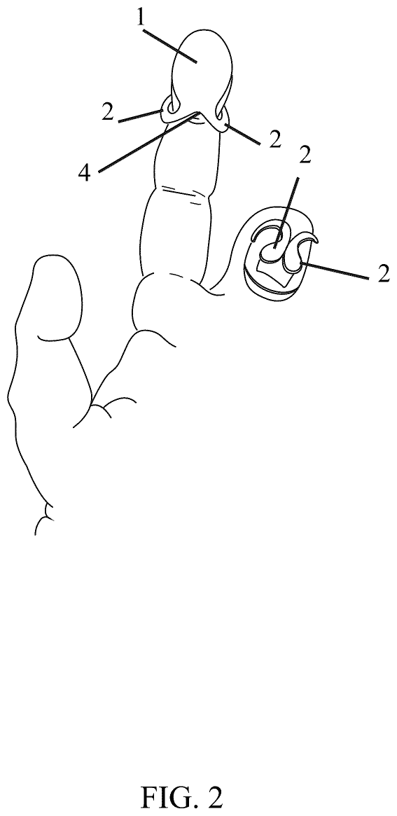

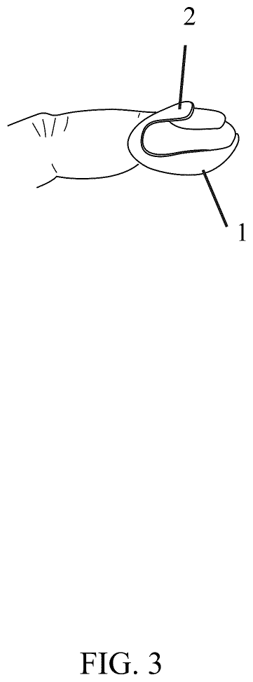

The present invention is a fingertip covering comprising solid material, including but not limited to stainless steel, steel, titanium, bronze, brass, copper, glass, porcelain, plastic, fiberglass, stone, carbon fiber, operculum, animal horn, or any combinations thereof. As shown in FIG. 1, the present invention comprises a central “fingertip” section shaped to roughly anatomical contours, and split bands (2) extending therefrom. The fingertip section (1) is placed on the user's fingertip, and the split bands (2) curve around the finger extending toward the fingertip allowing them to maintain sufficient pressure while enveloping a player's fingertip during use, as shown in FIG. 2. FIG. 3 shows a side view of the bands (2) curving around the finger. The present invention is anatomically curved to fit the natural contours of the user's fingers and fingertips. The bands (2) may be individually adjusted for comfort and snugness. The present invention may be manufactured in various sizes to further accommodate the user's fingers. The fingertip section (1) may further comprise an engraving (3), as shown in FIG. 1, which enhances the grip.

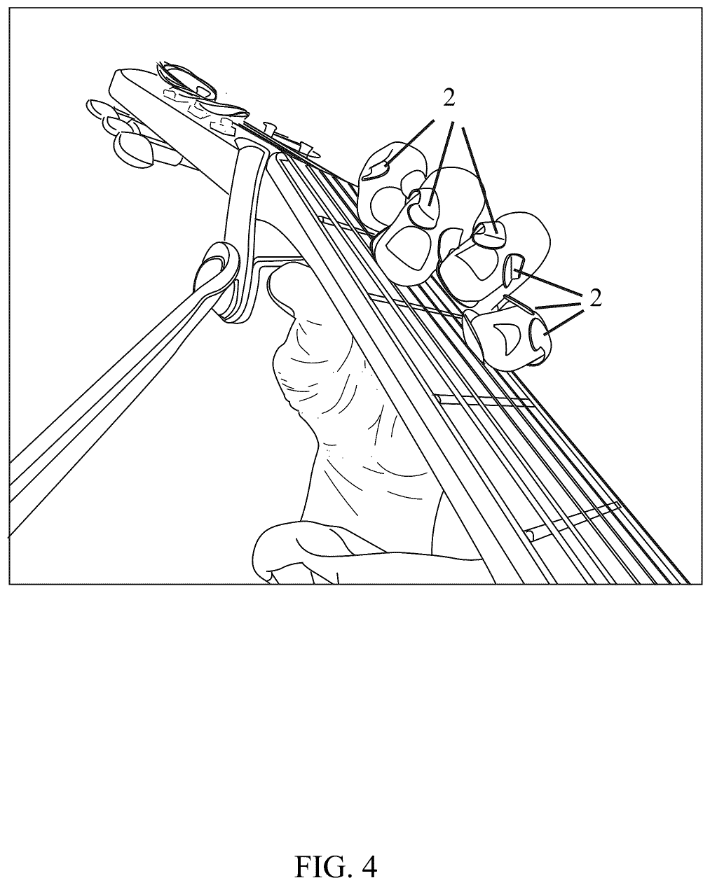

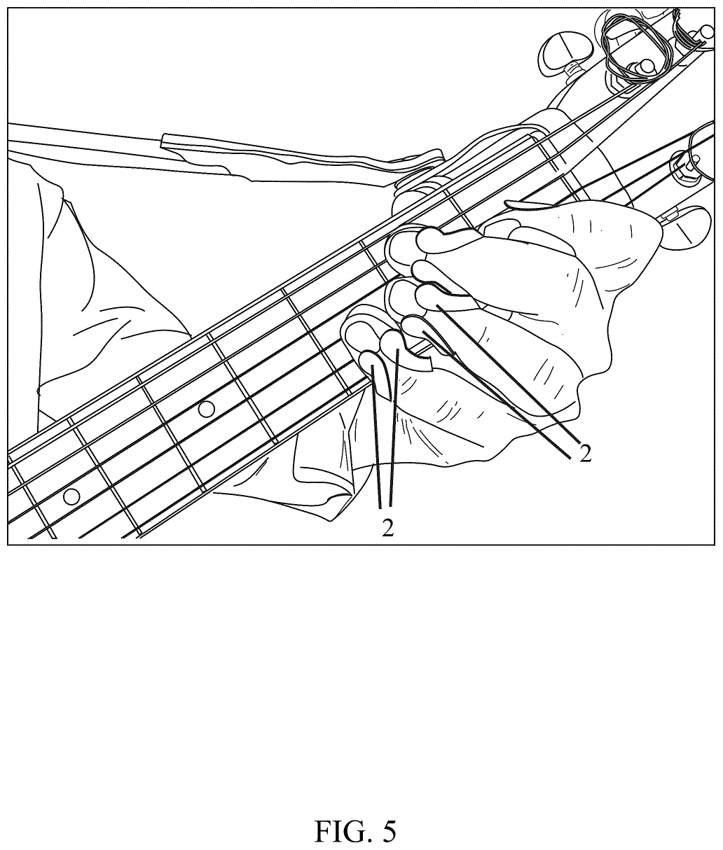

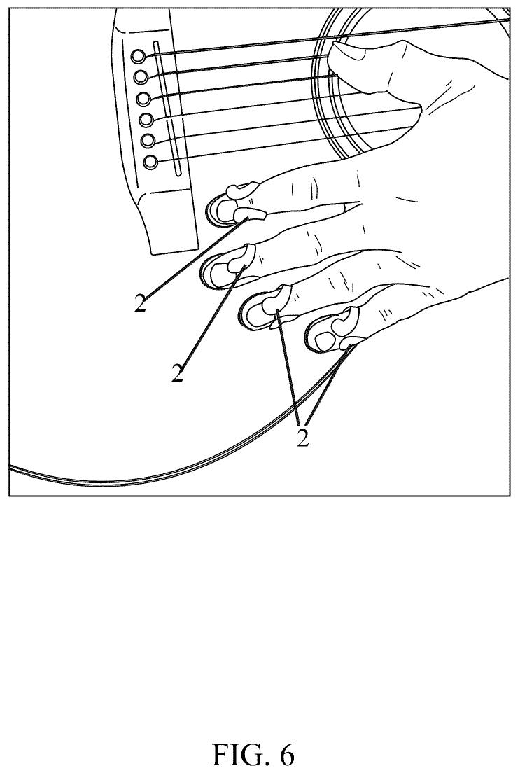

The present invention may vary in thickness. Different thicknesses create different sounds and tones when used as a slide on a guitar or other stringed instrument. Traditional slides are typically tubes through which the user inserts a finger, and they are used to alter the sound of the instrument and create various effects. The present invention retains this slide utility while also being smaller in size and weight and allowing the user to maintain control of individual fingertips. A user of the present invention may play traditionally with individual fingers as if bare handed but adding a slide sound to all four fingers. This allows the user further options to alter the sound of the instrument and create the desired effects. The present invention is shown in use in FIGS. 4-7. In addition to providing utility in creating slide and sound effects, the present invention may also be used to protect the fingers of new players.

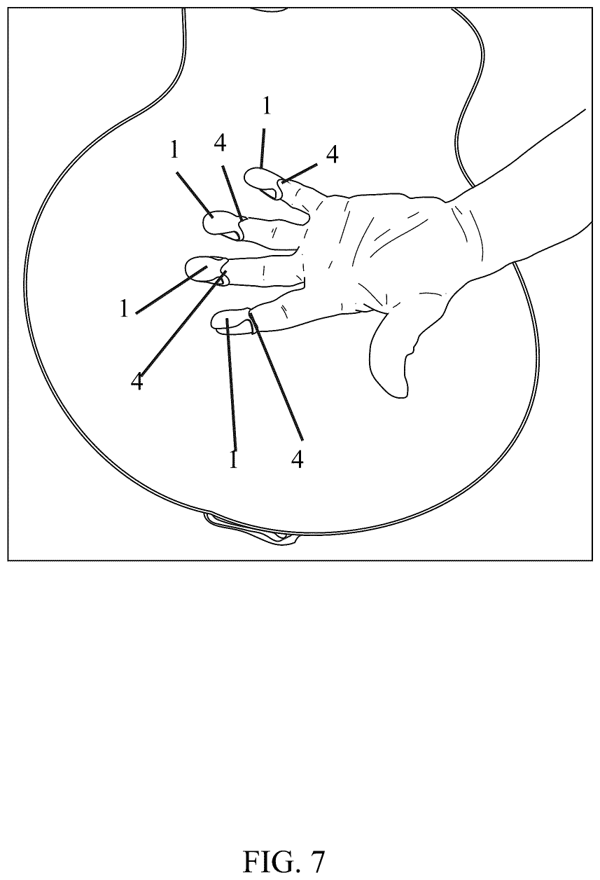

The present invention is fitted to stay firmly affixed to the user's fingertips and maintain a full range of motion without interfering with the natural movement of the player's fingers. The present invention further comprises a V-shaped relief (4) cut for the natural fold of the interior knuckle, as shown in FIG. 7. The present invention conforms closely to the finger, allowing the user's fingers to move more naturally without any interference. The relief (4) further allows for more ergonomic and natural finger movement. The material of the present invention is designed to cover only the surfaces of the finger that contact the strings without covering a finger's sides, allowing the user to adduct their fingers together without any gaps that would result from the thick side walls attributed the prior art, such as the '815 patent.

The present invention may further comprise a nano-coating applied to the surface, creating the ability to freely slide along the strings of the instrument. The nano-coating may also keep the present invention clean and free from dirt, sweat, and grime that may accumulate over time. Embodiments may also include a felt line or other gripping material to enhance the feel and/or control of the slide.

The present invention may provide further utility in other actions which may involve the fingers or fingertips. The solid material and secure fit of the present invention may be useful, for example, in sewing or needle-point to provide protection to the user's fingertips. The present invention may also prevent callouses for new guitar players or other stringed instrument players who wish to protect their fingertips while playing. Additional uses of the present invention are further contemplated and are within the scope of the present invention.

Although the invention has been explained in relation to its preferred embodiment, it is to be understood that many other possible modifications and variations can be made without departing from the spirit and scope of the invention.

What is claimed is:

1. A fingertip covering comprising,
a rounded central fingertip section;
a split band extending from the fingertip section, wherein the split band curves around the position a finger will hold to below the knuckle then back inward to snugly fit upon the finger when in place;
the fingertip section and split band being anatomically curved to fit the natural contours of the user's fingers and fingertips; and
the split band being adjustable for comfort and snugness.

2. The fingertip covering of claim 1, wherein the rounded central fingertip section is shaped to conform generally to the anatomy of a finger.

3. The fingertip covering of claim 1, wherein the fingertip covering comprises solid material such as metal, glass, porcelain, plastic, fiberglass or other solid materials.

4. The fingertip covering of claim 1, wherein the fingertip section comprises an engraving to enhance grip.

5. The fingertip covering of claim 1, wherein the covering varies in thickness to create different sounds and tones when used as a slide on a guitar or other stringed instrument.

6. The fingertip covering of claim 1, further comprising a V-shaped relief cut for the natural fold of the interior knuckle.

7. The fingertip covering of claim 1, further comprising a nano-coating applied to the surface to facilitate sliding along the strings of an instrument and to keep the covering clean.

8. The fingertip covering of claim 1, wherein the surface undergoes a deburring and smoothing process to remove sharp edges.

9. The fingertip covering of claim 1, wherein the interior facing surfaces are lined with a gripping material.

10. The fingertip covering of claim 9, wherein the gripping material is felt.

11. The fingertip covering of claim 1, wherein the covering is manufactured in various sizes to accommodate different finger sizes.
